(19) United States
(12) Patent Application Publication
(10) Pub. No.: US 2016/0131367 A1
(43) Pub. Date: May 12, 2016

(54) PORTABLE HEATING SYSTEM

(71) Applicant: Peter Nelson Stockwell, Minot, ND (US)

(72) Inventor: Peter Nelson Stockwell, Minot, ND (US)

(21) Appl. No.: 14/536,258

(22) Filed: Nov. 7, 2014

(51) Int. Cl. F24D 5/10; F24D 13/02; F24H 3/00

(52) U.S. Cl. CPC F24D 5/10; F24H 3/002; F24D 13/02; F27D 2099/0098

(57) ABSTRACT

A portable heating system includes a plenum chamber forming a base. The plenum chamber has a plurality of side walls and defines an upper opening. The side walls also define a plurality of side openings, each configured for attachment to an elongate flexible duct. A heating unit is coupled to the plenum and has an air intake opening for drawing air into the heating unit and an air vent opening for blowing warm air out of the heating unit, into the upper opening of the plenum chamber and out through the ducts. The ducts can be located throughout a structure to provide heating in various remote locations from the heating unit. A frame assembly is coupled to the plenum chamber and includes a handle for grasping by a user and a pair of wheels to allow the heating system to be moved.

### BACKGROUND

1. Field of the Invention

The present invention relates generally to portable heating systems and more specifically to a portable heating system that can be used to simultaneously heat several rooms or areas of a building.

2. State of the Art

Portable space heaters are known in the art and typically comprise a heating element and fan that is used to draw air through the heating element and to circulate the heated air into the space being heated. Such small space heaters are typically used when the primary heating system is not adequate to heat the room or when use of a primary heating system, such as a furnace, is too costly to operate or is not available. In a situation where only a single room is to be heated, the use of a space heater to heat the room can be less expensive than using the primary heating system, which often requires heating multiple rooms in order to provide heat to the desired room. Space heaters can also be used to provide localized heating for individuals that may be cold sensitive, such as the elderly, so that the temperature of the entire structure does not need to be raised in order to accommodate the one person.

Space heaters typically have an average output of between about 10,000 Btu and 40,000 Btu per hour. Most residential space heaters use electrically powered heating elements. Some industrial space heaters use the combustion of propane or natural gas to heat the space. Of course, the combustion of gases results in the product of carbon monoxide, which can be deadline if the space and/or combustion gases are not properly ventilated.

While most space heaters work by convection by circulating air in a room, others utilize radiant heating. Some radiant heaters employ infrared heating elements that radiate heat toward a specific location, heating objects and people positioned directly in front of the heater. Convection type space heaters often utilize a heat transfer liquid, such as oil, that is heated by an electric element. The heat transfer liquid stores heat from the heating element and provides a relatively constant heat source. Such convection type space heaters, however, take a relatively long time to heat a room or space. Typical electric space heaters are generally more expensive to operate than combustion space heaters, but they are the only unvented space heaters that are generally safe to operate inside an enclosed space.

Space heaters are classified as either vented or ventless. Ventless combustion type heaters are not recommended for enclosed spaces because they produce carbon monoxide as a result of the combustion process. While many states have banned unvented kerosene, propane or natural gas heaters for use in the home, for more industrial applications where large unheated rooms require heating, combustion type heating units are often employed. Vented remits, such as a furnace, are designed to be permanently installed and include a flue gas vent installed through a ceiling or directly through a wall to the outside. Such heating units usually have a duct to bring outside air into the combustion chamber. Less expensive combustion units use the room air for combustion and exhaust combustion gases into the room. As a result, it is often the case that exterior windows or doors must be opened to prevent the buildup of harmful combustion gases causing them to be rather inefficient,

In each of the foregoing examples, the space heater is placed within a room or space to heat that particular room or space. If additional rooms or spaces require heating where a single space heater is insufficient, additional space heaters are required. As a result, the cost if multiplied by the number of space heaters required.

Accordingly, it would be advantageous to provide a portable heating unit that simultaneously provides heat to multiple locations within a building or structure. In addition, it would be advantageous to provide a portable heating unit that utilizes an electric heating unit so that no venting of combustion gases is required. It would also be advantageous to provide a high output portable heating unit that is easy to operate and can be used in buildings or structures where no other source of heat is provided. These and other advantages are provided by a portable heating unit according to the present invention set forth hereinafter by incorporating an electric furnace as the heat source for the portable heating unit.

### SUMMARY OF THE INVENTION

Accordingly, the present invention overcomes many of the deficiencies and disadvantages of prior art space heater technologies by incorporating an electric furnace into the portable heating unit. A portable heating system of the present invention comprises a plenum chamber forming a base. The plenum chamber is formed from a plurality of side walls depending from a bottom panel and defining an upper opening. The plurality of side walls define a plurality of side openings, each side opening configured for attachment to an elongate flexible duct. A heating unit is coupled to the plenum and has an air intake opening for drawing air into the heating unit and an air vent opening for blowing warm air out of the heating unit and into the upper opening of the plenum chamber. A frame assembly is coupled to the plenum chamber and includes a handle for grasping by a user. A pair of wheels is rotatably coupled to the frame at a lower end thereof proximate a back end of the plenum chamber. Grasping the handle and tilting the frame assembly upon the wheels allows the user to maneuver the frame assembly and the heating unit with the wheels.

In one embodiment, the portable heating system includes a plurality of air duct attachment tubes, each air duct attachment tube coupled to one of the plurality of side openings of the plenum chamber.

In another embodiment, a plurality of caps are provided with each cap configured to be removably attached to one of the plurality of air duct attachment tubes to substantially prevent air entering the plenum chamber from exiting through the one of the plurality of air ducts to which the end cap is removably attached.

In yet another embodiment, the frame assembly comprises a pair of upwardly extending frame members coupled to and upwardly extending from a back end of the plenum chamber to proximate the handle.

In yet another embodiment, the frame assembly has a pair of downwardly extending legs coupled to a front end of the plenum chamber for supporting the plenum chamber above a support surface.

In still another embodiment, the frame assembly includes a pair of laterally extending frame members, each extending from a respective side of the plenum chamber proximate a front end thereof to a respective end of the handle and attached to an upper end of a respective upwardly extending frame members.

In another embodiment, the portable heating system includes a support panel coupled to and extending between the pair of upwardly extending frame members for providing lateral support to the frame assembly.

In yet another embodiment, an axel is coupled to and extending between the lower ends of the pair of upwardly extending frame members with the pair of wheels rotatably attached to the axel.

In another embodiment, a filter coupled to the air intake opening of the heating unit. The heating unit may comprise a commercially available electric furnace. A filter housing may also be included that is comprised of a sleeve configured to fit at least partially over a top portion of the heating unit and a lid configured to attach to the sleeve an hold a filter between the heating unit and the lid.

The present invention also includes a method of heating a building having a number of interconnected rooms utilizing a portable heating system according to the present invention. The method includes placing the heating system within a building to be heated having a plurality of interconnected rooms, connecting the heating unit to a source of electricity, coupling a plurality of elongate flexible ducts to a plurality of the plurality of side openings, extending a free end of each of the plurality of elongate flexible ducts into one of the plurality of rooms and turning on the heating unit to heat each of the plurality of rooms containing the free end of the plurality of flexible ducts. The plurality of air ducts are connected to the plurality of side openings of the plenum chamber. The handle of the portable heating system can be grasped by the handle of the frame assembly to maneuver the heating system.

To store the electrical cable, it can be wrapped around a plurality of support hooks attached to the frame.

Inserting a filter into the air intake opening of the heating unit provides filtered are from the heating unit, which may be a commercially available electric furnace, to the plenum. The filter may be attached with a filter housing having a sleeve configured to fit at least partially over a top portion of the heating unit and a lid configured to attach to the sleeve an hold a filter between the heating unit and the lid.

The foregoing advantages and characterizing features will become apparent from the following description of certain illustrative embodiments of the invention. The above-described features and advantages of the present invention, as well as additional features and advantages, will be set forth or will become more fully apparent in the detailed description that follows and in the appended claims. The novel features which are considered characteristic of this invention are set forth in the attached claims. Furthermore, the features and advantages of the present invention may be learned by the practice of the invention, or will be obvious to one skilled in the art from the description, as set forth hereinafter.

### BRIEF DESCRIPTION OF THE DRAWINGS

The following drawings illustrate exemplary embodiments for carrying out the invention. When considered in connection with the following illustrative figures, a more complete understanding of the present invention may be derived by referring to the detailed description. Like reference numerals refer to like parts in different views or embodiments of the present invention in the drawings.

FIG. 1 is a perspective side view of an embodiment of a portable heating system in accordance with the principles of the present invention.

FIG. 2 is a front side view of the portable heating system in accordance with the principles of the present invention as shown in FIG. 1.

FIG. 3 is a back side view of the portable heating system in accordance with the principles of the present invention as shown in FIG. 1.

FIG. 4 is a front side view of the portable heating system in accordance with the principles of the present invention as shown in FIG. 1 with a front panel removed.

FIG. 5 is a perspective view of a portable base of the portable heating system in accordance with the principles of the present invention as shown in FIG. 1. second embodiment of headphones containing an azimuth detector in accordance with the principles of the present invention.

FIG. 6 is a top side view of a metal sheet for forming a base of the portable base in accordance with the principles of the present invention as shown in FIG. 5.

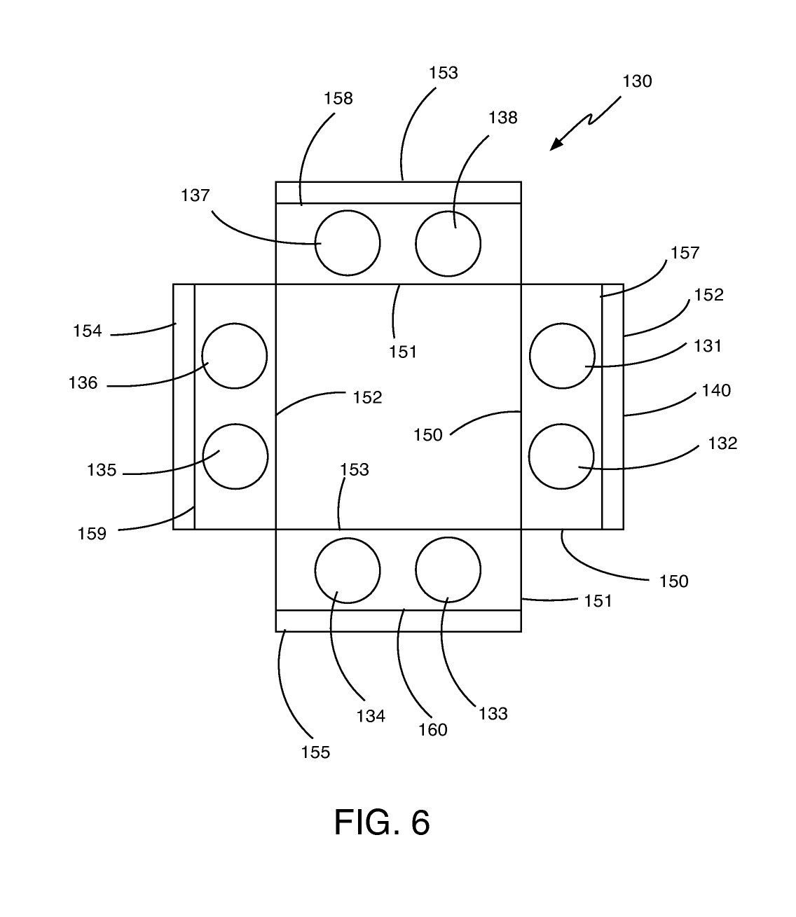

FIG. 7 is a partial cross-sectional back view of a wheel assembly of the portable heating system in accordance with the principles of the present invention.

FIG. 8 is a perspective side view of the portable heating system in accordance with the principles of the present invention as shown in FIG. 1 with a flexible duct attached to the base.

FIGS. 9A-9C are perspective side views of a filter housing for a portable heating system in accordance with the principles of the present invention.

FIG. 10 is a perspective side view of the filter housing shown in FIGS. 9A-9C attached to a base of a portable heating system in accordance with the principles of the present invention.

### DETAILED DESCRIPTION OF THE ILLUSTRATED EMBODIMENTS

Aspects and applications of the invention presented here are described in the drawings and in the following detailed description of the invention. Those of ordinary skill in the art will realize that the following description of the present invention is illustrative only and not in any way limiting. Other embodiments of the invention will readily suggest themselves to such skilled persons including, without limitation, combinations of elements of the various embodiments. Various representative implementations of the present invention may be applied to any heating system.

Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use the plain and ordinary meaning of terms in the specification and claims unless they clearly state otherwise in which case, the inventor will set forth the “special” definition of that term and explain how it differs from the plain and ordinary meaning. Absent such statements of the application of a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112(f). Thus, the use of the words “function,” “means” or “step” in the Detailed Description of the Invention or claims is not intended to somehow indicate a desire to invoke the special provisions of 35 U.S.C. §112(f) to define the invention. To the contrary, if the provisions of 35 U.S.C. §112(f) are sought to be invoked to define the inventions, the claims will specifically and expressly state the exact phrases “means for” or “step for” and the specific function (e.g., “means for heating”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. §112(f). Moreover, even if the provisions of 35 U.S.C. §112(f) are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. Thus, the full scope of the inventions is not limited to the examples that are described below.

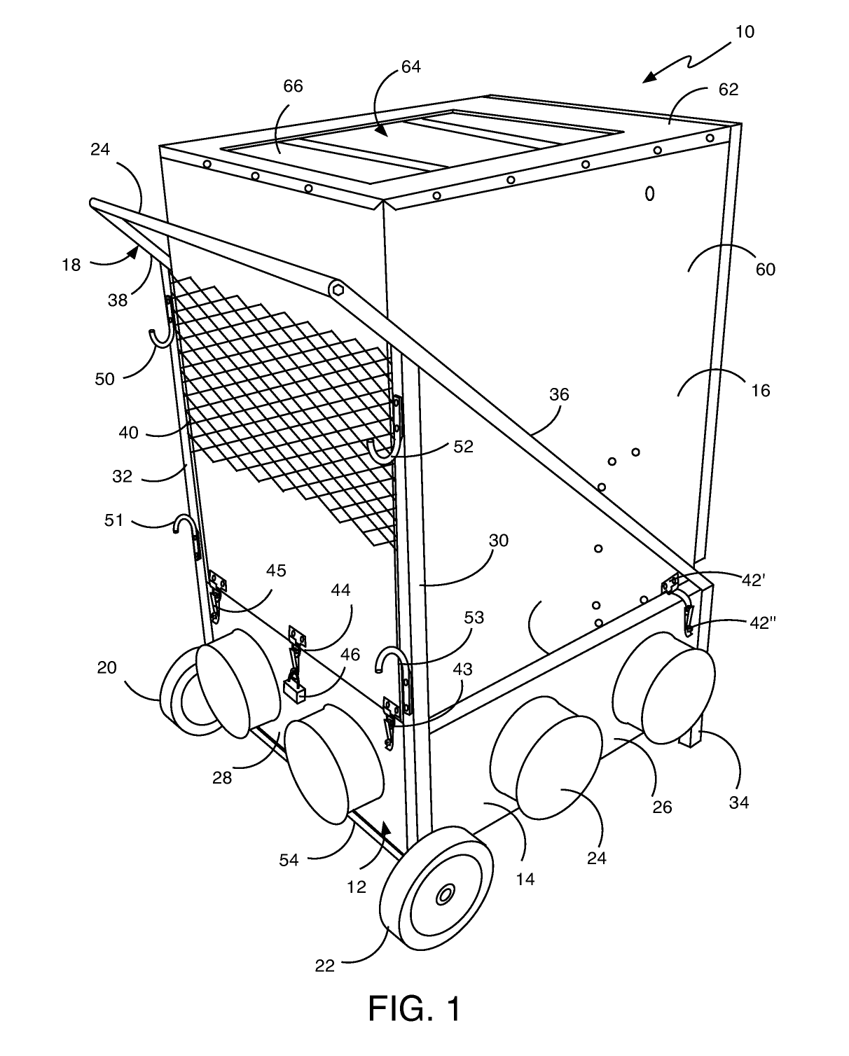

FIG. 1 illustrates a heating system, generally indicated at 10 in accordance with the principles of the present invention. The portable heating system 10 is configured to heat a plurality of rooms or spaces, or combinations thereof, as desired, by connecting a plurality of ducts to the heating system 10 and positioning the open free end of each duct at a location to be heated. Often times, when construction workers are working on an unfinished home or building with a number of interconnected rooms or spaces, the heating system of that structure has not yet been installed and/or is not yet operable. The heating system 10 of the present invention can be centrally located within the structure and, so long as the heating system 10 can be connected to electrical power, can be operated to heat the space within the rooms or locations where people are working. That is, rather than require the use of one or more space heaters to heat the entire building or structure, or substantial portions thereof, the heating system of the present invention can be utilized to provide localized heating where work is being performed and heating is desired.

The portable heating system 10 is comprised of a base 12 having a plenum chamber 14 upon which is coupled a heating unit 16, such as a commercially available electric furnace such as those commonly used in mobile homes. A frame assembly 18 is coupled to the base 12 and includes at least one set of wheels 20 and 22 for maneuvering the heating system 10 to a desired location. The frame assembly 18 also includes a handle 24 for grasping by a user to allow a user to push or pull the heating system 10 to a desired location. The frame assembly 18 includes a pair of upwardly extending rear members 30 and 32 that form the back corners of the frame 18 and a pair of downwardly extending legs (only leg 34 of which is visible) that form the front corners of the frame assembly 18. Angled members 36 and 38 extend along respective sides of the heating system 10 between upper ends of the legs, such as leg 34, and the rear members 30 and 32, respectively. Lateral stability between the rear members 30 and 32 is provided by a panel 40 of wire mesh that is attached to and between the rear members 30 and 32.

The plenum chamber 14 is generally a rectangular or square box-shaped structure having a plurality of openings (not visible) formed in the sides thereof to each of which, as will be shown and described in more detail herein, a flexible duct can be attached. As shown in FIG. 1, when not in use, each opening is covered by a cap, such as cap 24. Each cap 24 can be selectively removed to expose a duct attachment tube (not visible) to which a flexible duct (not shown) can be attached. The plenum chamber 14 includes a pair of duct openings (not visible) on each side, such as sides 26 and 28, to allow for a total of eight ducts that can potentially be attached to the plenum chamber 14 for heating eight separate rooms or spaces, eight areas of a large space or any combination thereof.

The heating unit 16 rests upon the plenum chamber 14 and is coupled to the plenum chamber 14 with a plurality of latch mechanisms, such as latch mechanisms 42-45. Each latch mechanism 42-45 is comprised of a hook portion, such as hook portion 42′ and a latch portion 42″. If desired, one or more latch mechanisms, such as latch mechanism 44, can be locked together with a pad lock 46. Coupling the heating unit 16 to the base 12 allows the heating system to be maneuvered to a desired location without the heating unit 16 becoming dislodged from the base 12.

A plurality of J hooks 50-53 are mounted to the upright members 30 and 32, with the upper J hooks 50 and 52 oriented in one direction and the J hooks 51 and 53 oriented in the opposite direction (i.e., rotated 180 degrees). The J hooks 50-53 are provided, as will be described in more detail to wrap a power cord for the heating unit 16 around the J hooks 50-53.

The lower ends of the upright members 30 and 32 support an axel 54 to which the wheels 20 and 22 are rotatably coupled. Because the handle 24 is positioned rearwardly of the wheels 20 and 22, a user can tip or tilt the heating system 10 back on the wheels 20 and 22 to raise the front legs, such as leg 34, in order to maneuver the heating system 10 to any desired location. In addition, because the wheels 20 and 22 are located at the back end of the heating system 10, the heating system 10 can be relatively easily pulled up or lowered down a flight of stairs (not shown) by grasping the handle 24.

The heating unit 16 includes an outer housing 60 having an upper end 62 and a lower end 64. The upper end 62 defines an upper intake opening 64 through which air is drawn by the heating unit 16, heated and then the warm air is forced into the plenum 14 through a lower vent opening (not visible) for distribution out of the plenum 14. A filter 66 is positioned within the upper opening 64 to filter air being drawn into the heating unit 16. This is particularly important for industrial or other work settings, such as a construction site, where the heating system of the present invention might be employed. In such environments, there is likely to be airborne particles, such as saw dust and the like, that would otherwise enter the heating unit 16 and be deposited on the heating element and/or heat exchanger (not visible). By filtering the air with the filter 66 before it enters the heating unit 16, build up of airborne particles within the heating unit 16 can be avoided or at least reduced.

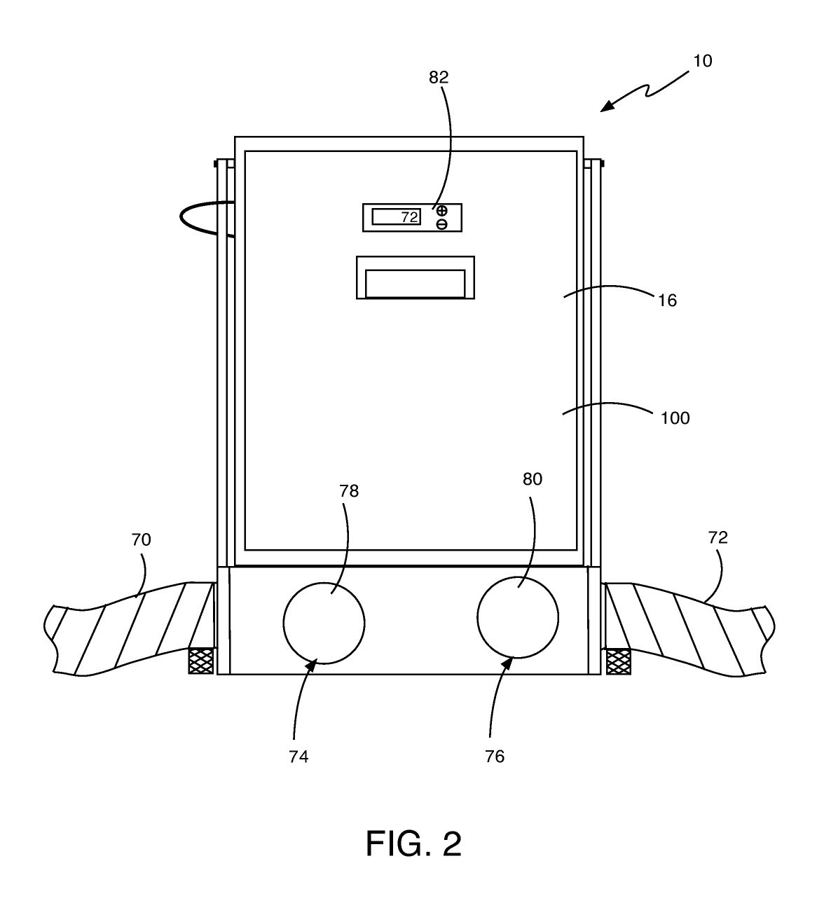

As shown in FIG. 2, a plurality of ducts 70 and 72 can be simultaneously coupled to the plenum and be extended into different areas of a building (not shown). Other ports or openings 74 and 76 of the plenum are covered with caps 78 and 80, respectively. Another port, not visible, can simply be left open to heat the area directly around the heating system 10. The heating system 10 may include a user controllable thermostat 82 that may be coupled to the front panel 100 of the heating unit 16, so that a specific desired temperature can be set in order to trigger operation of the heating system according the surrounding air temperature. Similarly, the heating system 10 may include a remote thermostat that can be placed at the location of the free end of a duct in order to control operation of the heating system 10 according to an air temperature at a location that is remote from the heating unit 16. The remote thermostat can be wirelessly connected to the heating unit 16 so that a wired connection is not required.

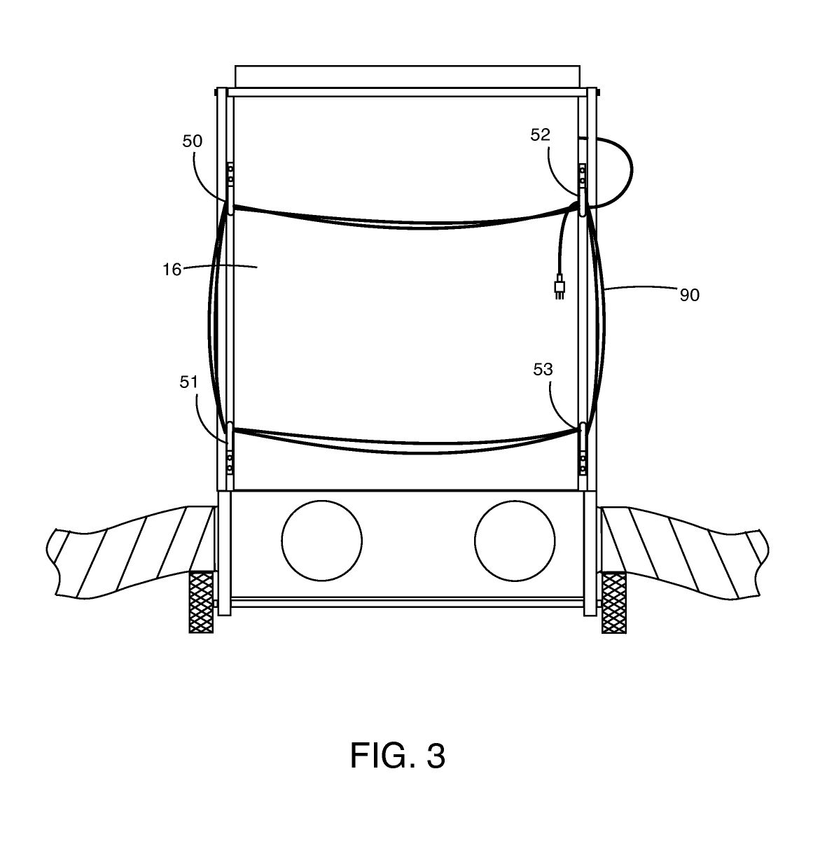

As shown in FIG. 3, the heating unit 16 is an electric furnace that is electrically powered. An electrical cord 90 is electrically connected to the heating unit 16 to provide power to the heating unit. When not in use, the electrical cord 90 can be wrapped around the J hooks 50-53 for storage.

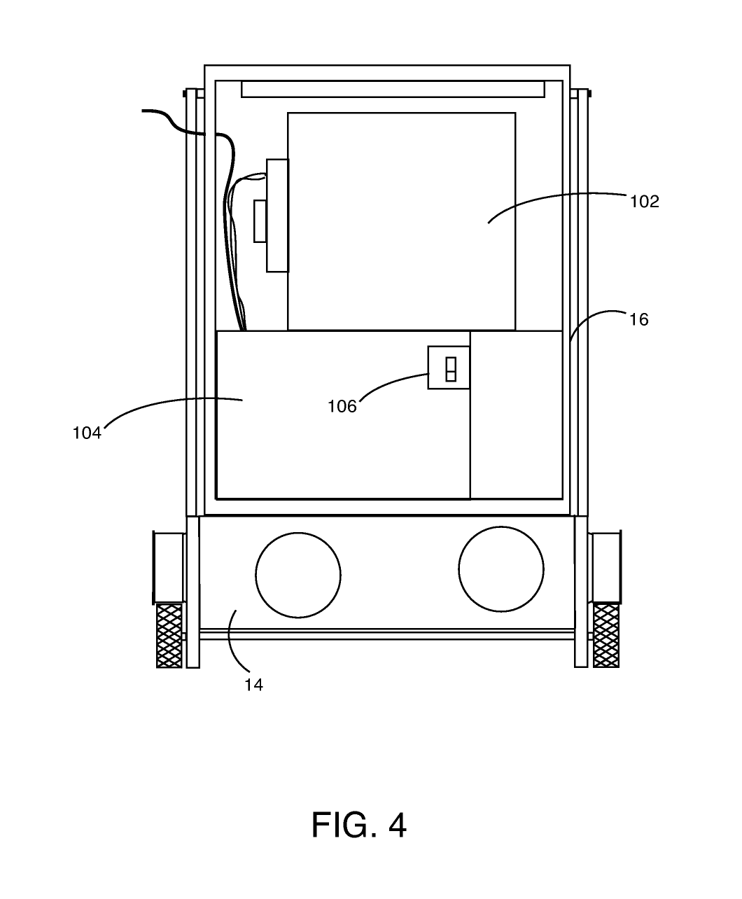

Referring now to FIG. 4, with the front panel 100 (see FIG. 3) removed, the heating unit 16 includes a blower 102 mounted above a heating chamber 104 housing an electrical heating element (not visible). The heating chamber 104 is in fluid communication with the plenum 14 so as air is blown from the blower 102 into the heating chamber 104, the heated air is forced into the plenum 14 through an opening (not visible) in the bottom of the heating unit 16. As the blower 102 continues to force air through the heating chamber 104, the heated air becomes pressurized within plenum chamber 14 to cause an equalized flow of heated air through each open port in the plenum 14. The heating unit 16 includes a power switch 106 to turn the heating unit 16 on and off.

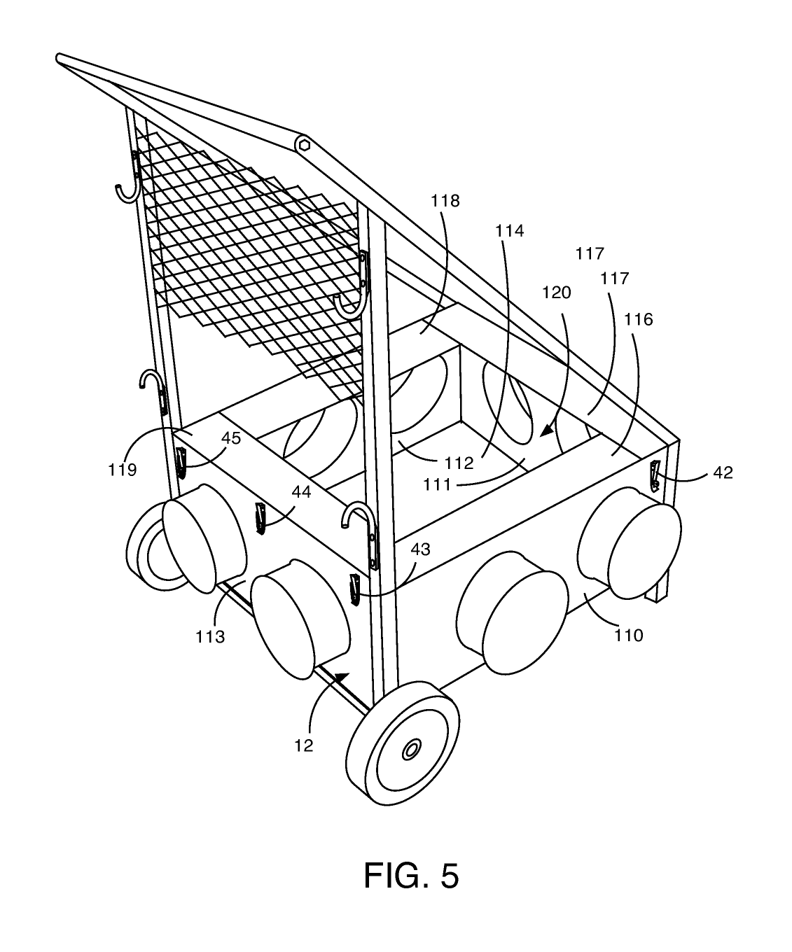

As further illustrated in FIG. 5, the plenum chamber 14 of the base 12 is comprised of side walls 110-113, a bottom panel 114 and a plurality of upper support walls 116-119 that inwardly depend from each of the side walls 110-113, respectively, and provide a support surface for supporting a bottom of the heating unit 16 (see FIG. 1). The upper support walls 116-119 define a top opening 120 to the plenum chamber 14 that is in fluid communication with a bottom opening to a heating unit, such as heating unit 16, attached thereto. The width of each of the upper support walls 116-119 are such that the base 12 can accommodate a variety of heating units that heat and direct air in a downward direction. Many furnaces are configured to be operated in either orientation so that even a furnace configured to direct heated air in an upward direction can be flipped upside down and still operate effectively. For heating units that are slightly smaller than the outside width and depth of the plenum, the latch mechanisms 42-45 are configured to attach to and secure a heating unit having a smaller base. For example, the latch 42 has a latch portion that extends over a portion of the top of the plenum to attach to the hook portion 42′ (see FIG. 1).

A plenum 130 according to the principles of the present invention can be formed from a single sheet 140. The sheet 140 is cut into a T-shaped configuration as shown and a plurality of holes 131-138 forming the openings of the plenum 130 are cut into the portions that will form the side walls of the plenum 130. The sheet may be comprised of sheet metal, such as galvanized sheet metal typically used for residential ducting for heating and air conditioning. Once the sheet is formed as shown with the holes 131-138 cut therein, the sheet is folded approximately 90 degrees along lines 150-153 until the adjacent edges, such as edges 150 and 151, of each portion that will form the side walls abut one another. The edges can then be welded to form an airtight seam between the edges 150 and 151. The outer ends 152-155 are folded inwardly folded 90 degrees along lines 157-160, respectively, to form the upper support surface upon which a heating unit will rest. Of course, those of skill in the art will appreciate that the plenum 130 could be formed from a number of individual overlapping pieces that are formed and joined together by various methods known in the art such as welding, rivets or other fasteners.

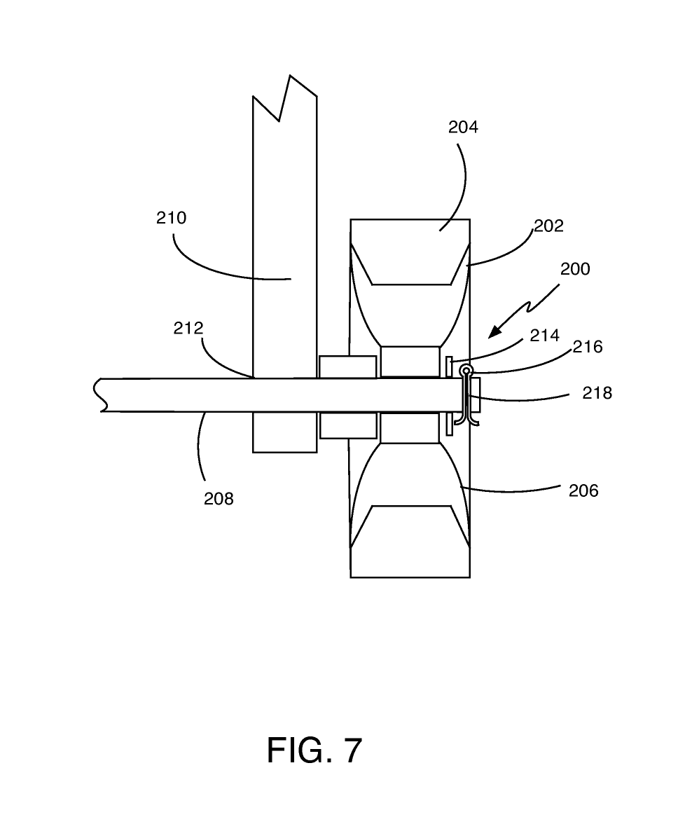

As shown in FIG. 7, each wheel assembly, such as wheel assembly 200, is comprised of a wheel 202 having a tire 204 and a rim 206 rotatably coupled to an axel 208. The axel 208 is supported relative to an upright member 210 forming part of the frame of the base as previously described herein. A hole 212 transversely extends through the bottom end of the upright member 210 and the axel extends through the hole 212. A spacer is positioned on the axel adjacent an outer side of the upright member 210 to hold the wheel 202 away from the upright member 210. The rim 206 of the wheel 202 is rotatably attached to the portion of the axel 208 extending from the upright member 210 and is held thereon with a washer 214 and pin 216 that transversely extends through a hole 218 in the axel 208. The wheel 202 can freely rotate upon the axel 208. A similar but opposite configuration is provided for the other wheel assembly. By providing the length of the axel 208 to accommodate the span between the upright members as well as the wheels and spacers, the wheels remain positioned adjacent the spacers during use.

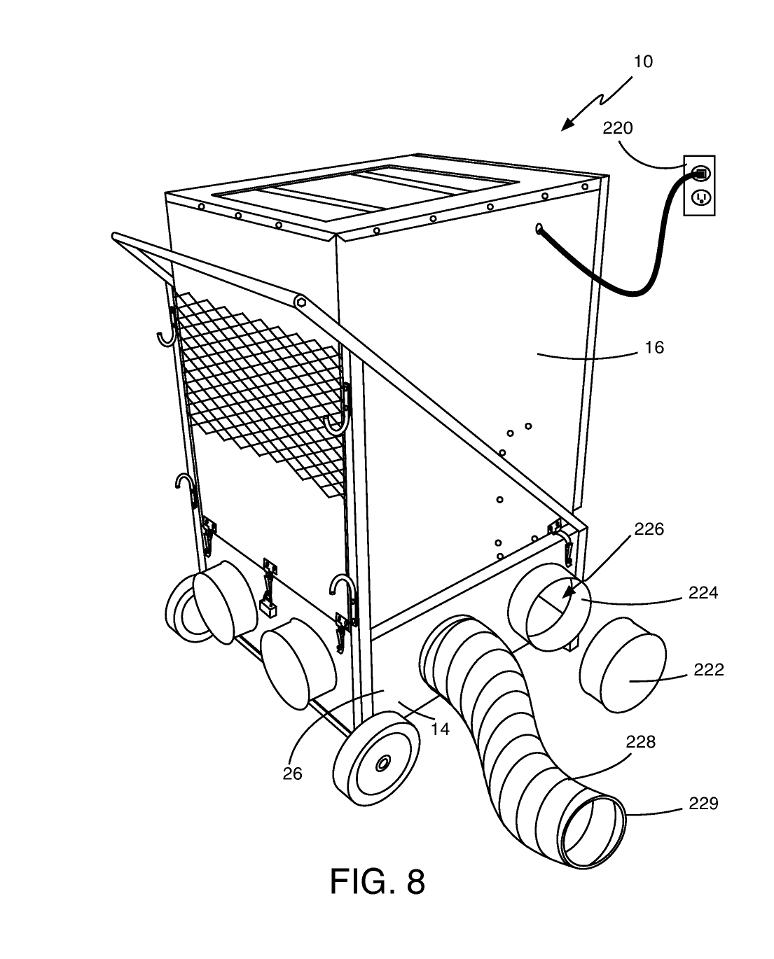

FIG. 8 illustrates the heating system 10 of the present invention in use. The heating unit 16 is plugged into an electrical plug 220 of a structure in order to provide power to the heating unit 16. One or more caps 222 are removed from the plenum 14. When a cap 22 is removed from the plenum, a duct attachment tube 224 is exposed. The duct attachment tube is coupled to the opening 226 defined by the side wall 26 of the plenum 14 and extends therefrom. The cap 22 is generally cylindrically shaped with one end enclosed to prevent air significant air from escaping through the opening 226 when the cap 22 is attached to the tube 224 and is thus sized to be slightly larger than the duct attachment tube 224 but removably coupled to the tube 224 with a relatively snug friction fit. Once a cap 222 is removed, a flexible duct 228 is coupled to the 224 as with a friction fit. Air forced into the plenum 14 will then be forced out through the duct 228. The flexible duct 228 is one of a standard size known in the art, having a configuration similar to that of a dryer vent hose, specifically, a flexible material tube supported by a spirally disposed wire. Relatively any length of a flexible duct 228 can be used so long as the air in the duct remains heated once the air exits the duct 228. As such, the free end 229 of the duct 228 can be positioned in virtually any desired location relative to the heating unit 16 to provide remote heating of spaces away from the heating unit 16. Of course, the BTU output and CFM of air produced by the heating unit 16 are sufficient to provide adequate heating and air flow for a plurality of air ducts attached to the plenum 14. For example and not by way of limitation, the diameter of each duct could be 3, 4 or 6 inches. Based on the diameter of each duct, the number and lengths of ducts that can be simultaneously attached to the plenum 14 and the size of the space to be heated, a properly sized heating unit 16 can be determined.

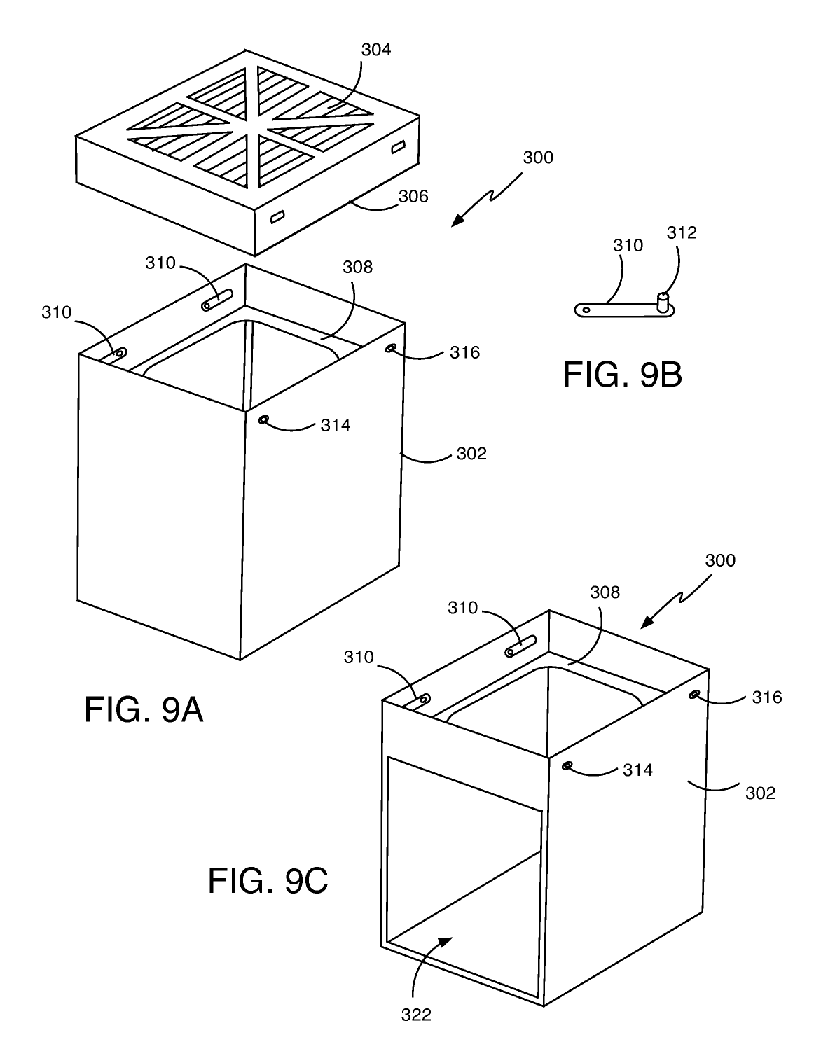

As illustrated in FIGS. 9A-9C, a filter housing, generally indicated at 300, may be provided to cover the heating unit 16 shown in FIG. 8. The filter housing 300 is comprised of a rectangular sleeve 302 configured to slip over the heating unit 16. Thus, the bottom of the sleeve 302 is open for placement over the heating unit 16. The top of the sleeve 302 is also open for receiving a filter 304 that is sized and shaped to fit therein. Spaced a distance from the top of the sleeve 302 approximately equal to a thickness of the filter 304 is a rim or abutment surface 308 that extends around the inner perimeter of the sleeve 302 to essentially provide a shelf upon which the filter 304 can rest. A lid 306 is configured to fit over the top end of the sleeve 302 and to be coupled thereto in a removable manner. The sleeve 302 and lid 306 may be comprised of sheet metal, such as stainless steel, galvanized steel or aluminum, from plastic or other materials known in the art.

The lid 306 is held to the sleeve 302 with a plurality of biased fasteners, such as fastener 310 shown in FIG. 9B. Each fastener is comprised of a metal strip coupled to the sleeve at one end, such as with a rivet, and includes a button 312 for extending through apertures 314 and 316 in the sides of the sleeve 302 and through apertures 318 and 320 in the sides of the lid 306. Because the fasteners 310 are held at one end and can be inwardly pressed at the other by the button 312, the lid 306 can be selectively coupled and removed from the sleeve 302.

As further shown in FIG. 9C, the front of the sleeve 302 defines an opening 322. The opening 322 is sized and shaped to fit around the front door of the heating unit 16 so that the front door of the heating unit can be accessed and opened if necessary without having to remove the sleeve 302. This allows access to the heating unit 16 for repairs or other reasons, such as for making electrical connections inside the heating unit 16 to a power source.

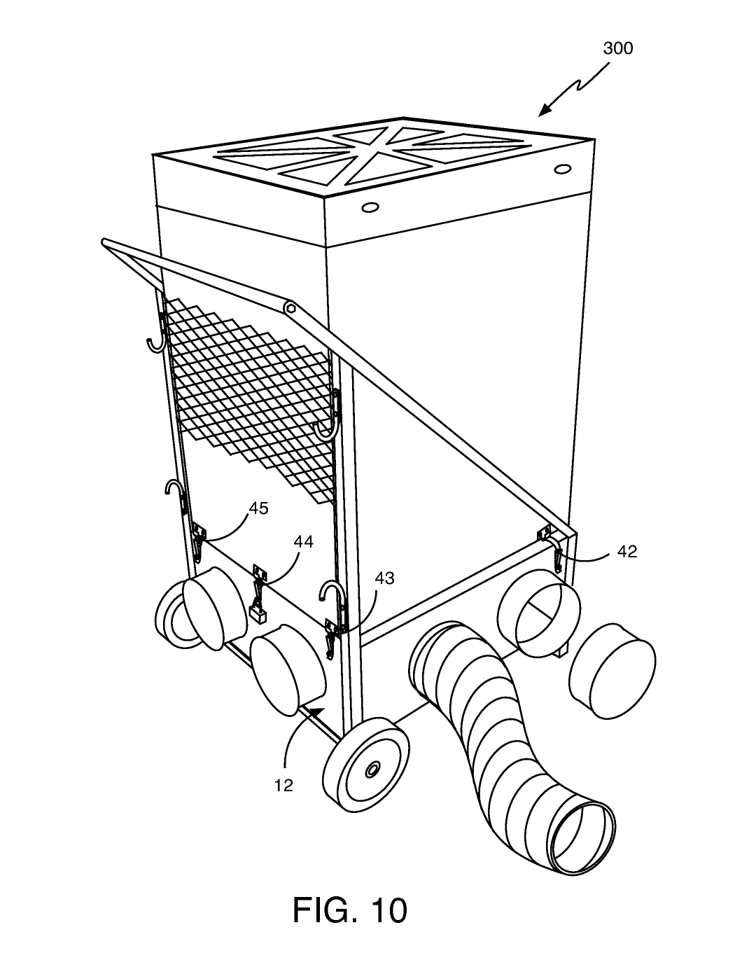

As shown in FIG. 10, the filter housing 300 is configured to be attached to the base 12 (see FIG. 5). The filter housing 300 is coupled to the base 12 with a plurality of latch mechanisms 42-45 in order to secure the filter housing 300 and thus the heating unit contained therein to the base 12. By providing the filter housing 300 and locking the filter housing to the base 12, the heating unit 16 (see FIG. 8) cannot be removed from the base 12 without unlocking the filter housing 300 from the base 12. Thus, securing the base 12 to a permanent object, as with a chain, can deter theft of the heating unit. It should be noted, however, that while the filter housing 300 is configured to extend from the top of the heating unit to the base 12, the filter housing could be configured to simply rest upon the top of the heating unit so as to only extend a just below the top surface of the heating unit. Other configurations will become apparent to those of skill in the art upon consideration of the disclosure of the present invention set forth herein and are intended to be incorporated herein. For example, the lid could be configured to extend over the top edge of the heating unit to hold the filter on top of the heating unit.

In the foregoing specification, the present invention has been described with reference to specific exemplary embodiments. Various modifications and changes may be made, however, without departing from the spirit and scope of the present invention as set forth in the claims. The specification and figures are illustrative, not restrictive, and modifications are intended to be included within the scope of the present invention. Accordingly, the scope of the present invention should be determined by the claims and their legal equivalents rather than by merely the examples described. For example, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

It would be apparent to those skilled in the art that other heat sources, or other modifications could be employed in a similar manner for portable heating without departing from the inventive concepts herein. Thus, while there have been described various embodiments of the present invention, those skilled in the art will recognize that other and further changes and modifications may be made thereto without department from the spirit of the invention, and it is intended to claim all such changes and modifications that fall within the true scope of the invention. It is also understood that, as used herein and in the appended claims, the singular forms “a,” “an,” and “the” include plural reference, unless the context clearly dictates otherwise.

Unless defined otherwise, all technical and scientific terms used herein have the same meanings as commonly understood by one of ordinary skill in the art to which this invention belongs. While various methods and structures of the present invention are described herein, any methods or structures similar or equivalent to those described herein may be used in the practice or testing of the present invention. All references cited herein are incorporated by reference in their entirety and for all purposes. In addition, while the foregoing advantages of the present invention are manifested in the illustrated embodiments of the invention, a variety of changes can be made to the configuration, design and construction of the invention to achieve those advantages including combinations of components of the various embodiments. Hence, reference herein to specific details of the structure and function of the present invention is by way of example only and not by way of limitation.

What is claimed is:

1. A portable heating system, comprising;
a plenum chamber forming a base, the plenum chamber formed from a plurality of side walls depending from a bottom panel and defining an upper opening, the plurality of side walls defining a plurality of side openings, each side opening configured for attachment to an elongate flexible duct;
a heating unit coupled to the plenum having an air intake opening for drawing air into the heating unit and an air vent opening for blowing warm air out of the heating unit and into the upper opening of the plenum chamber;
a frame assembly coupled to the plenum chamber comprising a handle for grasping by a user; and
a pair of wheels rotatably coupled to the frame at a lower end thereof proximate a back end of the plenum chamber, whereby grasping the handle and tilting the frame assembly upon the wheels allows the user to maneuver the frame assembly and the heating unit with the wheels.

2. The portable heating system of claim 1, further comprising a plurality of air duct attachment tubes, each air duct attachment tube coupled to one of the plurality of side openings of the plenum chamber.

3. The portable heating system of claim 2, further comprising a plurality of caps, each cap configured to be removably attached to one of the plurality of air duct attachment tubes to substantially prevent air entering the plenum chamber from exiting through the one of the plurality of air ducts to which the end cap is removably attached.

4. The portable heating system of claim 1, wherein the frame assembly comprises a pair of upwardly extending frame members coupled to and upwardly extending from a back end of the plenum chamber to proximate the handle.

5. The portable heating system of claim 4, wherein the frame assembly further comprises a pair of downwardly extending legs coupled to a front end of the plenum chamber for supporting the plenum chamber above a support surface.

6. The portable heating system of claim 5, wherein the frame assembly further comprises a pair of laterally extending frame members, each extending from a respective side of the plenum chamber proximate a front end thereof to a respective end of the handle and attached to an upper end of a respective upwardly extending frame members.

7. The portable heating system of claim 6, further comprising a support panel coupled to and extending between the pair of upwardly extending frame members for providing lateral support to the frame assembly.

8. The portable heating system of claim 4, further comprising an axel coupled to and extending between the lower ends of the pair of upwardly extending frame members with the pair of wheels rotatably attached to the axel.

9. The portable heating system of claim 8, further comprising a filter coupled to the air intake opening of the heating unit.

10. The portable heating system of claim 1, wherein the heating unit comprises a commercially available electric furnace.

11. The portable heating system of claim 1, further comprising a filter housing comprising a sleeve configured to fit at least partially over a top portion of the heating unit and a lid configured to attach to the sleeve an hold a filter between the heating unit and the lid.

12. A method of heating a building having a number of interconnected rooms utilizing a portable heating system, comprising;
providing a heating system comprising:
a plenum chamber forming a base, the plenum chamber formed from a plurality of side walls depending from a bottom panel and defining an upper opening, the plurality of side walls defining a plurality of side openings, each side opening configured for attachment to an elongate flexible duct;
a heating unit coupled to the plenum having an air intake opening for drawing air into the heating unit and an air vent opening for blowing warm air out of the heating unit and into the upper opening of the plenum chamber;
a frame assembly coupled to the plenum chamber comprising a handle for grasping by a user; and
a pair of wheels rotatably coupled to the frame at a lower end thereof proximate a back end of the plenum chamber, whereby grasping the handle and tilting the frame assembly upon the wheels allows the user to maneuver the frame assembly and the heating unit with the wheels;
placing the heating system within a building to be heated having a plurality of interconnected rooms;
connecting the heating unit to a source of electricity;
coupling a plurality of elongate flexible ducts to a plurality of the plurality of side openings;
extending a free end of each of the plurality of elongate flexible ducts into one of the plurality of rooms; and
turning on the heating unit to heat each of the plurality of rooms containing the free end of the plurality of flexible ducts.

13. The method of claim 12, further comprising coupling the plurality of air ducts to a plurality of air duct attachment tubes coupled to one of the plurality of side openings of the plenum chamber.

14. The method of claim 13, further comprising removing a plurality of caps, each cap configured to be removably attached to one of the plurality of air duct attachment tubes to substantially prevent air entering the plenum chamber from exiting through the one of the plurality of air ducts to which the end cap is removably attached.

15. The method of claim 12, further comprising grasping the handle of the frame assembly to maneuver the heating system.

16. The method of claim 14, further comprising using a pair of downwardly extending legs coupled to a front end of the plenum chamber for supporting the plenum chamber above a support surface.

17. The method of claim 12, further comprising wrapping an electrical cable around a plurality of support hooks attached to the frame for storing the electrical cable.

18. The method of claim 12, further comprising inserting a filter into the air intake opening of the heating unit.

19. The method of claim 12, wherein providing a heating system comprises coupling a commercially available electric furnace to the plenum.

20. The method of claim 12, wherein providing a heating system comprises providing a filter housing having a sleeve configured to fit at least partially over a top portion of the heating unit and a lid configured to attach to the sleeve an hold a filter between the heating unit and the lid.
